(19) United States
(12) Patent Application Publication
(10) Pub. No.: US 2008/0209547 A1
(43) Pub. Date: Aug. 28, 2008

(54) Electronic device and information processing method

(75) Inventors: Takeshi Funahashi, Saitama (JP); Takeshi Koyama, Tokyo (JP); Yoshihiro Nakamura, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/003,982

(22) Filed: Jan. 4, 2008

(30) Foreign Application Priority Data
Feb. 27, 2007 (JP) 2007-047330

(51) Int. Cl. G06F 12/14

(52) U.S. Cl. 726/20

(57) ABSTRACT

An electronic device including a non-volatile memory and connectable to an information processing apparatus, including the following elements: a sensor configured to sense biometric information; an authentication unit configured to perform user authentication on the basis of the biometric information sensed by the sensor; a management unit configured to manage a number of authentication failures, the number of authentication failures being the number of times the authentication performed by the authentication unit has failed; and a controller configured to disable the electronic device or delete data stored in the non-volatile memory in a case where the number of authentication failures exceeds a preset threshold number of times.

### CROSS REFERENCES TO RELATED APPLICATIONS

The present invention contains subject matter related to Japanese Patent Application JP 2007-047330 filed in the Japanese Patent Office on Feb. 27, 2007, the entire contents of which are incorporated herein by reference.

### BACKGROUND OF THE INVENTION

1. Field of the Invention

The present invention relates to electronic devices and information processing methods, and more particularly, to an electronic device and an information processing method for reliably preventing data leakage.

2. Description of the Related Art

As the cost of flash memories have decreased and the storage capacity thereof have increased in recent years, universal serial bus (USB) memories have become widely used as devices for storing data created by personal computers (PCs). A user plugs a USB memory into a USB terminal provided in the user's PC, and the PC can recognize the USB memory as an external storage medium and store data in the USB memory.

Some USB memories have a fingerprint authentication function. For example, when a user places a finger on a sensor provided on the surface of a housing containing a USB memory which is plugged into a PC, the sensor detects a fingerprint, and the USB memory matches the detected fingerprint against a registered fingerprint. If the user is successfully authenticated, the user is allowed to read, using the PC, data stored in the USB memory.

Accordingly, data can be read only when authentication is successful. Privacy data stored in the USB memory is prevented from being read by people other than the user.

Japanese Unexamined Patent Application Publication No. 2006-155217 describes the technique of allowing an upper-level device to recognize an external storage device when authentication performed by an authentication device is successful. Japanese Unexamined Patent Application Publication No. 2006-146358 describes the technique of storing in a USB key a program for controlling access to a USB peripheral device from an external terminal, a program for authenticating the execution of the program, and the like and preventing information leakage from the USB peripheral device.

### SUMMARY OF THE INVENTION

Fingerprint-based authentication is performed at a false accept rate of a one ten-thousandth or one hundred-thousandth. This is a very small rate, but it is not zero. When an unlimited number of authentication attempts are allowed, and if a USB memory is lost or stolen, a person other than the authenticate user may access internal data stored in the USB memory, resulting in leakage of the internal data.

It is desirable to prevent data leakage in a more reliable manner.

According to an embodiment of the present invention, there is provided an electronic device including a non-volatile memory and connectable to an information processing apparatus. The electronic device includes the following elements: sensing means for sensing biometric information; authentication means for performing user authentication on the basis of the biometric information sensed by the sensing means; management means for managing a number of authentication failures, the number of authentication failures being the number of times the authentication performed by the authentication means has failed; and control means for disabling the electronic device or deleting data stored in the non-volatile memory in a case where the number of authentication failures exceeds a preset threshold number of times.

The electronic device may further include a volatile memory. In this case, the management means may manage the number of authentication failures by updating a first count value indicating the number of authentication failures as a first number of times, the first count value being stored in the volatile memory. The control means may disable the electronic device or delete the data stored in the non-volatile memory in a case where the first number of times exceeds the threshold number of times.

The management means may store a second count value indicating a second number of times in the non-volatile memory at a predetermined time, the second number of times being the same number of times as the first number of times.

In a case where at least partial operation of the electronic device is performed using power supplied from the information processing apparatus connected to the electronic device, the management means may store in the volatile memory the first count value indicating the first number of times, the first number of times being the same number of times as the second number of times, when the electronic device is connected to the information processing apparatus and power is supplied from the information processing apparatus to the electronic device.

The electronic device may further include computing means for randomly computing a value indicating a number of times less than or equal to the threshold number of times. In this case, the management means may store in the non-volatile memory the second count value indicating the second number of times, the second number of times being the same number of times as the first number of times, at a time when the number of times indicated by the value computed by the computing means is less than or equal to the first number of times.

The management means may reset the first count value and the second count value in a case where the authentication performed by the authentication means is successful.

The management means may manage a value indicating the threshold number of times by storing the value indicating the threshold number of times in the non-volatile memory.

According to another embodiment of the present invention, there is provided an information processing method for an electronic device including a non-volatile memory and connectable to an information processing apparatus, including the steps of: sensing biometric information; performing user authentication on the basis of the sensed biometric information; managing the number of times the authentication has failed; and disabling the electronic device or deleting data stored in the non-volatile memory in a case where the managed number of times exceeds a preset threshold number of times.

According to the embodiments of the present invention, biometric information is sensed, and user authentication is performed on the basis of the sensed biometric information. The number of times the authentication has failed is managed. In a case where the managed number of times exceeds a preset threshold number of times, the electronic device is disabled, or data stored in the non-volatile memory is deleted.

According to the embodiments of the present invention, data leakage can be more reliably prevented.

### BRIEF DESCRIPTION OF THE DRAWINGS

FIG. 1 is an external view of an exemplary appearance of a USB memory with a fingerprint matching function according to an embodiment of the present invention;

FIG. 2 is a block diagram of an exemplary hardware structure of the USB memory with the fingerprint matching function;

FIG. 3 illustrates exemplary areas formed in a flash memory;

FIG. 4 is a block diagram of an exemplary functional structure of the USB memory with the fingerprint matching function;

FIG. 5 illustrates exemplary data stored in a random-access memory (RAM) and the flash memory;

FIG. 6 is a flowchart of a fingerprint registering process performed by the USB memory with the fingerprint matching function;

FIG. 7 is a flowchart of an authentication process performed by the USB memory with the fingerprint matching function;

FIG. 8 is a flowchart, continued from FIG. 7, of the authentication process performed by the USB memory with the fingerprint matching function;

FIG. 9 illustrates a specific example of updating count values;

FIG. 10 illustrates the specific example of updating the count values;

FIG. 11 illustrates the specific example of updating the count values;

FIG. 12 illustrates the specific example of updating the count values;

FIG. 13 illustrates another specific example of updating the count values;

FIG. 14 illustrates the specific example of updating the count values; and

FIG. 15 illustrates the specific example of updating the count values.

### DESCRIPTION OF THE PREFERRED EMBODIMENTS

Before describing an embodiment of the present invention, the correspondence between the features of the claims and the embodiment disclosed in the specification or shown in the drawings is discussed below. This description is intended to assure that the embodiment supporting the claimed invention is described in the specification or shown in the drawings. Thus, even if an element in the following embodiment is described in the specification or shown in the drawings, but is not described as relating to a certain feature of the claims, that does not necessarily mean that the element does not relate to that feature of the claims. Conversely, even if an element is described herein as relating to a certain feature of the claims, that does not necessarily mean that the element does not relate to other features of the claims.

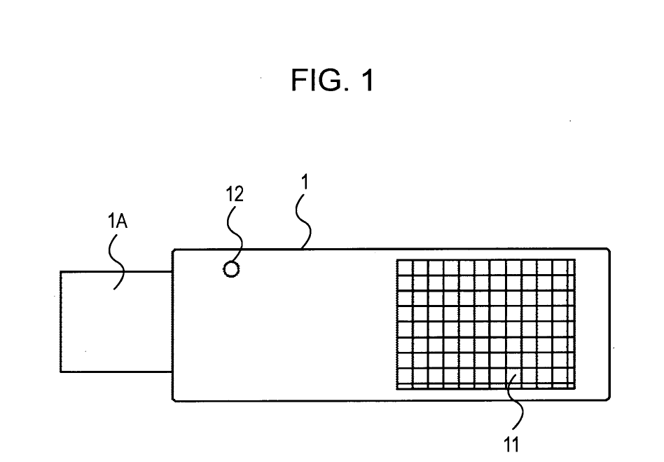

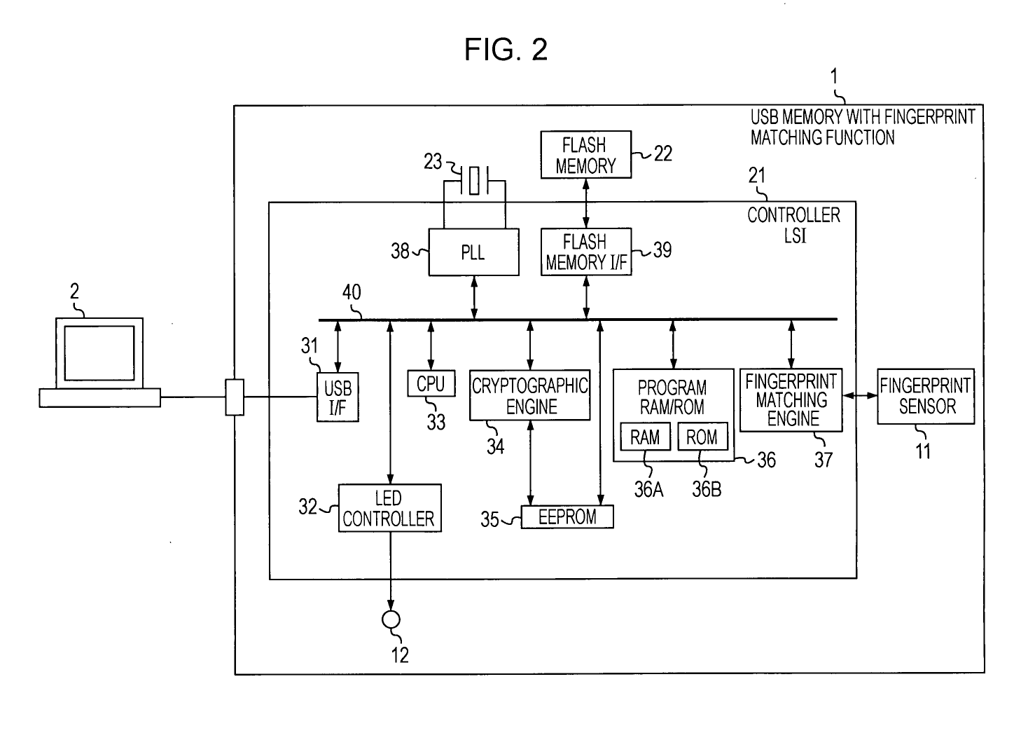

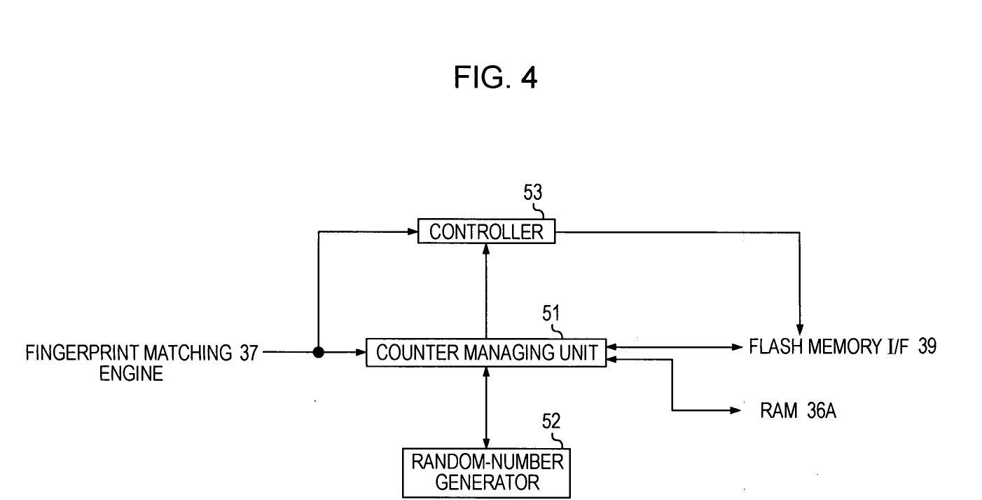

An electronic device according to an embodiment of the present invention is an electronic device (e.g., a USB memory 1 with a fingerprint matching function, which is shown in FIG. 1) including a non-volatile memory (e.g., e.g., a flash memory 22 shown in FIG. 2) and connectable to an information processing apparatus. The electronic device includes the following elements: sensing means (e.g., a fingerprint sensor 11 shown in FIG. 2) for sensing biometric information; authentication means (e.g., a fingerprint matching engine 37 shown in FIG. 2) for performing user authentication on the basis of the biometric information sensed by the sensing means; management means (e.g., a counter managing unit 51 shown in FIG. 4) for managing the number of times the authentication performed by the authentication means has failed; and control means (e.g., a controller 53 shown in FIG. 4) for disabling the electronic device or deleting data stored in the non-volatile memory in the case where the number of times managed by the management means exceeds a preset threshold number of times.

The electronic device may further include a volatile memory (e.g., a RAM 36A shown in FIG. 2).

The electronic device may further include computing means (e.g., a random-number generator 52 shown in FIG. 4) for randomly computing a value indicating a number of times less than or equal to the threshold number of times.

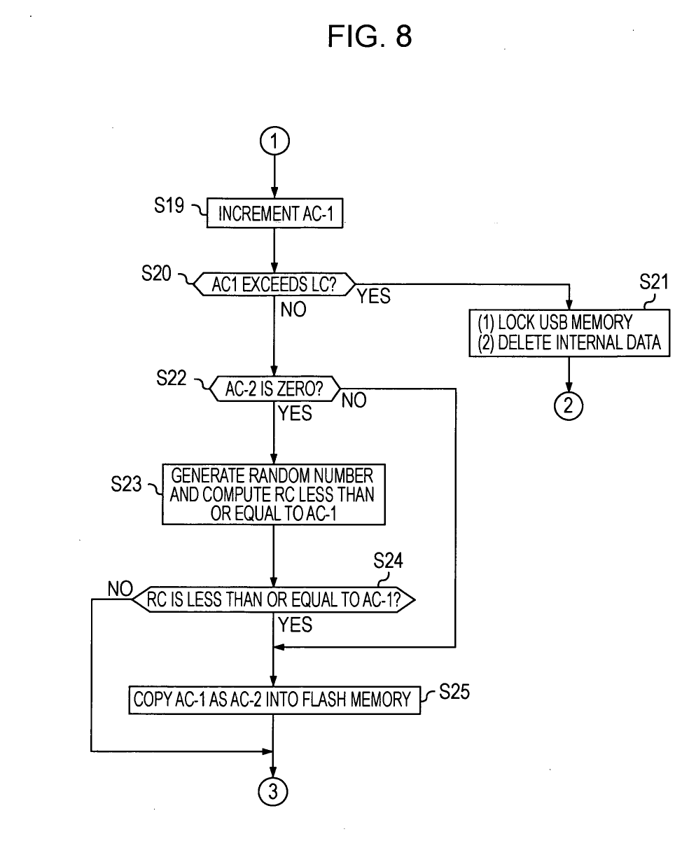

An information processing method according to another embodiment of the present invention is an information processing method for an electronic device including a non-volatile memory and connectable to an information processing apparatus, including the steps of: sensing biometric information; performing user authentication on the basis of the sensed biometric information; managing the number of times the authentication has failed; and disabling the electronic device or deleting data stored in the non-volatile memory in the case where the managed number of times exceeds a preset threshold number of times (e.g., step S21 in FIG. 8).

An embodiment of the present invention will now herein be described in detail below with reference to the drawings.

FIG. 1 is an external view of an exemplary appearance of a USB memory 1 with a fingerprint matching function (hereinafter simply referred to as a USB memory 1).

The USB memory 1 includes a box-shaped housing. A USB terminal 1A provided on one side of the housing is plugged into, for example, a PC provided with a USB terminal, and the USB memory 1 is connected to the PC.

The USB memory 1 includes a flash memory. A user of the USB memory 1 plugs the USB memory 1 into the PC, and the PC recognizes the USB memory 1 as an external storage medium. Various pieces of data created using the PC can be stored in the USB memory 1.

A fingerprint sensor 11 is provided and exposed on the surface of the housing of the USB memory 1. When using the USB memory 1 as an external storage medium of the PC, the user is asked to place the underside of a finger on the fingerprint sensor 11 while the USB memory 1 is plugged into the PC, and the fingerprint sensor 11 performs fingerprint matching. The USB memory 1 matches the user's fingerprint data sensed by the fingerprint sensor 11 against the user's pre-registered fingerprint data stored in the USB memory 1. When the two pieces of data match each other, the user can transfer data from the PC to the USB memory 1 and store the data in the USB memory 1 or read data stored in the USB memory 1 using the PC.

A finger-placement light-emitting diode (LED) 12 is provided on the surface of the housing of the USB memory 1. The finger-placement LED 12 starts blinking when the USB memory 1 is plugged into the PC and power is supplied from the PC to the USB memory 1. Accordingly, the user is prompted to place a finger on the fingerprint sensor 11 to be authenticated on the basis of the user's fingerprint.

The USB memory 1 with the foregoing appearance has a function of disabling the USB memory 1 itself or deleting the entire data stored in its internal flash memory in the case where fingerprint-based authentication attempts are consecutively unsuccessful, the number of which exceeds a preset threshold. The disabled state includes the state where no fingerprint-based authentication can be performed even when the USB memory 1 is plugged into a PC.

This prevents situations where a person who has obtained the USB memory 1 from the owner in an unauthorized manner or, in the case where the owner has lost the USB memory 1, a person who has found the lost USB memory 1 repeatedly makes authentication attempts using his/her fingerprint, and, if authentication is eventually successful, the USB memory 1 recognizes the unauthorized person as the valid owner, and the unauthorized person can access data stored in the internal flash memory.

Fingerprint-based authentication may happen to accept an unauthorized person's fingerprint as a valid fingerprint. When an unlimited number of authentication attempts are allowed, eventually authentication will be successful. Thus, at a time when fingerprint-based authentication attempts are consecutively unsuccessful, the number of which exceeds a threshold number of times, the USB memory 1 is disabled thereafter. In this way, an unlimited number of authentication attempts are not allowed, and hence data leakage can be more reliably prevented.

A process of disabling the USB memory 1 or deleting the entire data stored in the flash memory, which is performed by the USB memory 1, will be described later with reference to flowcharts.

FIG. 2 is a block diagram of an exemplary hardware structure of the USB memory 1. The same reference numerals are given to the same components as those shown in FIG. 1.

As shown in FIG. 2, the USB memory 1 basically includes a controller large-scale integrated circuit (LSI) 21, the fingerprint sensor 11, the finger-placement LED 12, a flash memory 22, and a crystal oscillator 23. The fingerprint sensor 11, the finger-placement LED 12, the flash memory 22, and the crystal oscillator 23 are connected to the controller LSI 21. Of these components, at least some of them operate using power supplied from a host PC 2 serving as an external information processing apparatus when the USB memory 1 is plugged into a USB terminal of the host PC 2.

The controller LSI 21 includes a USB interface (I/F) 31, an LED controller 32, a central processing unit (CPU) 33, a cryptographic engine 34, an electrically erasable and programmable read-only memory (EEPROM) 35, a program RAM/ROM 36, a fingerprint matching engine 37, a phase-locked loop (PLL) 38, and a flash memory I/F 39, which are interconnected by a bus 40.

The USB I/F 31 communicates with the host PC 2 in accordance with a USB standard. The USB I/F 31 receives data sent from the host PC 2 and outputs the received data to the bus 40. The data output to the bus 40 is encrypted by the cryptographic engine 34, supplied to the flash memory I/F 39, and stored in the flash memory 22.

In the case where data read from the flash memory 22 by the flash memory I/F 39 is decrypted by the cryptographic engine 34 and is supplied via the bus 40 to the USB I/F 31, the USB I/F 31 sends the data to the host PC 2.

The LED controller 32 allows the finger-placement LED 12 to emit light under control of the CPU 33.

The CPU 33 expands and executes a program stored in a ROM 36B of the program RAM/ROM 36 in a RAM 36B, thereby controlling the operation of the components interconnected by the bus 40.

For example, the CPU 33 increments a count value stored in the RAM 36A by one every time a notification of fingerprint-based authentication failure is sent from the fingerprint matching engine 37. When the number of times fingerprint-based authentication attempts are consecutively unsuccessful (the number of consecutive authentication failures), which is indicated by the count value, exceeds a threshold number of times, the CPU 33 locks the USB memory 1 or controls the flash memory I/F 39 to delete the entire data stored in the flash memory 22.

Accordingly, by coping the count value stored in the RAM 36A into the flash memory 22, the CPU 33 prevents an unauthorized act of removing the USB memory 1 from the host PC 2 at the time authentication attempts are consecutively unsuccessful, thereby resetting the number of consecutive authentication failures up to that point. Since the RAM 36A is a volatile memory, when the USB memory 1 is removed from the host PC 2 and no power is supplied to the USB memory 1, data including the count value stored in the RAM 36A is deleted.

If the count value is stored only in the RAM 36A, removable of the USB memory 1 from the host PC 2 before the number of consecutive authentication failures exceeds the threshold number of times resets the count value. By repeating such removable and plugging of the USB memory 1, an unlimited number of authentication attempts can be made. According to the embodiment, the count value stored in the RAM 36A is copied, that is, saved, into the flash memory 22 which is a non-volatile memory at a predetermined time before the removable of the USB memory 1 from the host PC 2, and, when the USB memory 1 is plugged into the host PC 2 again, the number of consecutive authentication failures is managed on the basis of the number of times indicated by the count value stored in the flash memory 22. Therefore, an unlimited number of authentication attempts are not allowed.

In the case where the count value is stored only in the flash memory 22 and the number of consecutive authentication failures is managed by updating that count value, the problem of allowing an unlimited number of authentication attempts by resetting the count value can be overcome. In this case, however, the life of the flash memory 22 is critical.

That is, the flash memory 22 including a NAND flash memory or the like is a memory which can be rewritten a limited number of times, as compared with the RAM 36A. If the count value stored in the flash memory 22 is updated every time an authentication attempt fails, the number of remaining erase/writes is reduced. In order to overcome this problem, the count value to be updated is the count value stored in the RAM 36A, and the count value stored in the RAM 36A is copied to the flash memory 22 less frequently than the frequency of updating the count value stored in the RAM 36A. Accordingly, the life of the flash memory 22 can be extended, while preventing unauthorized acts.

The CPU 33 controls access from the host PC 2 to the flash memory 22. Upon receipt of a notification of successful fingerprint-based authentication from the fingerprint matching engine 37, the CPU 33 permits access to the flash memory 22.

In the case where data to be written, which is sent from the host PC 2, is supplied via the bus 40 to the cryptographic engine 34, the cryptographic engine 34 encrypts the data using an encryption key stored in the EEPROM 35 and outputs the encrypted data to the flash memory I/F 39.

In the case where data stored in the flash memory 22 is read by the flash memory I/F 39 and supplied to the cryptographic engine 34, the cryptographic engine 34 decrypts the supplied, encrypted data using the encryption key stored in the EEPROM 35 and outputs the decrypted data to the USB I/F 31, and the USB I/F 31 sends the decrypted data to the host PC 2.

The EEPROM 35 stores an encryption key such as the Advanced Encryption Standard (AES) or the Data Encryption Standard (DES). If necessary, the encryption key stored in the EEPROM 35 is read by the cryptographic engine 34 and is used for encrypting data or decrypting encrypted data. The encryption key stored in the EEPROM 35 is generated at the time a user registers his/her fingerprint using, for example, part of the registered fingerprint data and pre-stored data in the EEPROM 35.

The program RAM/ROM 36 includes the RAM 36A and the ROM 36B. Besides a program executed by the CPU 33, various pieces of data necessary for the CPU 33 to perform various processes are stored in the program RAM/ROM 36. As has been described above, the RAM 36A stores the count value indicating the number of consecutive authentication failures.

When an integrated value of the signal level of radio frequency (RF) signals output by sensing a fingerprint in a plurality of relatively small preset ranges of the fingerprint sensor 11 exceeds a threshold value, the fingerprint matching engine 37 determines that a finger has been placed on the fingerprint sensor 11 and starts sensing the fingerprint.

The fingerprint matching engine 37 matches the fingerprint sensed on the basis of an output from the fingerprint sensor 11 against a fingerprint template stored in the flash memory 22 and finds a feature match. When a feature of the sensed fingerprint matches a feature represented by the fingerprint template, the fingerprint matching engine 37 determines that the user who has placed the finger on the fingerprint sensor 11 is the valid user and sends a notification that the fingerprint-based authentication was successful to the CPU 33.

The fingerprint template is encrypted by the encryption key stored in the EEPROM 35 and stored in the flash memory 22. When finding a fingerprint match, the fingerprint matching engine 37 receives a supply of the fingerprint template that has been decrypted by the cryptographic engine 34 using the encryption key.

The PLL 38 generates a clock necessary for allowing the components of the controller LSI 21 to operate on the basis of a clock supplied from the crystal oscillator 23 and supplies the generated clock to the components.

The flash memory I/F 39 controls data writing to and reading from the flash memory 22.

For example, the flash memory I/F 39 stores in the flash memory 22 data encrypted by the cryptographic engine 34 and supplied via the bus 40. The flash memory I/F 39 reads encrypted data stored in the flash memory 22 and outputs the read data to the cryptographic engine 34 via the bus 40.

The flash memory 22 stores various pieces of data under control of the flash memory I/F 39.

The crystal oscillator 23 outputs a clock with a predetermined frequency to the PLL 38.

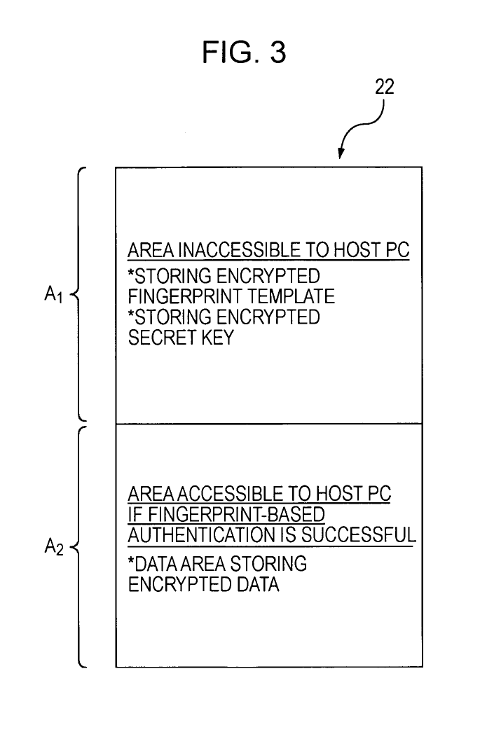

FIG. 3 illustrates exemplary areas formed in the flash memory 22.

As shown in FIG. 3, the entire storage area of the flash memory 22 can be divided into an area A₁ and an area A₂.

The area A₁ stores the fingerprint template that has been encrypted using the encryption key stored in the EEPROM 35, and a secret key (individual key). The area A₁ is the area inaccessible to the host PC 2 since no information regarding the data stored in the area A₁ is sent from the USB memory 1 to the host PC 2 even after a successful fingerprint-based authentication.

The secret key stored in the area A₁ is used for decrypting data encrypted by another device using a public key corresponding to the secret key. The secret key is also used to generate electronic signature data added to data created by the user using the host PC 2.

As has been described above, the USB memory 1 stores keys for use in realizing a public key infrastructure (PKI), keys for encrypting and decrypting data, and the like. The USB memory 1 has the function as a hardware token.

In contrast, the area A₂ stores data encrypted using the encryption key stored in the EEPROM 35. The area A₂ becomes accessible to the host PC 2 after a successful fingerprint-based authentication. Data can be transferred from the host PC 2 to the area A₂ and stored in the area A₂, or data stored in the area A₂ can be read by the host PC 2.

The encryption of data for storage into the area A₂ and the decryption of encrypted data stored in the area A₂ for reading the data are automatically performed in the USB memory 1 in accordance with a command sent from the host PC 2. It is therefore not necessary for the host PC 2 to be aware of encryption processing when reading and writing data.

FIG. 4 is a block diagram of an exemplary functional structure of the USB memory 1. At least some of functional parts shown in FIG. 4 are realized by executing a predetermined program on the CPU 33 shown in FIG. 2.

As shown in FIG. 4, the USB memory 1 realizes a counter managing unit 51, a random-number generator 52, and a controller 53. A notification of successful/unsuccessful authentication is input from the fingerprint matching engine 37 to the counter managing unit 51 and the controller 53.

The counter managing unit 51 manages the number of consecutive authentication failures using a counter and stores a count value indicating the number of consecutive authentication failures in the RAM 36A and the flash memory 22. The count value stored in the RAM 36A and the flash memory 22 is reset by the counter managing unit 51 upon receipt of a notification of successful authentication from the fingerprint matching engine 37.

In the case where the number of times indicated by the count value stored in the RAM 36A exceeds a preset threshold number of times, the counter managing unit 51 controls the controller 53 to lock the USB memory 1 or to delete the data stored on the area A₂ of the flash memory 22. The value indicating the threshold number of times is stored in, for example, the flash memory 22. The counter managing unit 51 allows the random-number generator 52 to generate a random number.

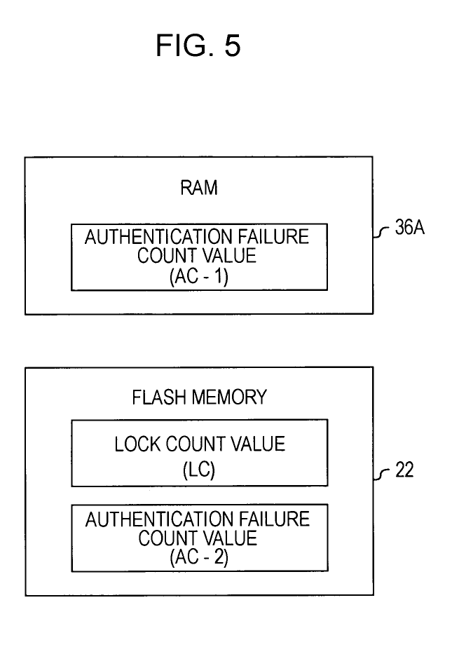

FIG. 5 illustrates exemplary data which is stored in the RAM 36A and the flash memory 22 and managed by the counter managing unit 51.

As shown in FIG. 5, the RAM 36A stores an authentication failure count value indicating the number of consecutive authentication failures. The flash memory 22 stores an authentication failure count value and a lock count value serving as a threshold used to determine the time to lock the USB memory 1.

The lock count value is generated in accordance with, for example, the upper limit of the number of consecutive authentication failures specified by the user at the time the USB memory 1 was initialized and is stored in the flash memory 22. The authentication failure count value and the lock count value may be stored in the area A₁ or the area A₂ of the flash memory 22, as shown in FIG. 3.

The authentication failure count value stored in the flash memory 22 is a copy of the authentication failure count value stored in the RAM 36A, which is made at a predetermined time. Since copying from the RAM 36A to the flash memory 22 is done less frequently than the frequency of updating the authentication failure count value stored in the RAM 36A, the authentication failure count value stored in the RAM 36A may indicate, depending on the time, a value different from that indicated by the authentication failure count value stored in the flash memory 22.

In the following description, the authentication failure count value stored in the RAM 36A is referred to as a value AC-1, and the authentication failure count value stored in the flash memory 22 is referred to as a value AC-2. The lock count value stored in the flash memory 22 is referred to as a value LC.

Referring back to FIG. 4, the random-number generator 52 generates a random number under control of the counter managing unit 51 and outputs the generated random number to the counter managing unit 51. The random number generated by the random-number generator 52 is used to determine the time to copy the value AC-1 stored in the RAM 36A as the value AC-2 into the flash memory 22.

On the basis of a notification from the fingerprint matching engine 37, the controller 53 controls the flash memory I/F 39 and manages access of the host PC 2 to the flash memory 22. For example, upon receipt of a notification of successful authentication from the fingerprint matching engine 37, the controller 53 permits access to the flash memory 22. Upon receipt of a notification of authentication failure from the fingerprint matching engine 37, the controller 53 forbids access to the flash memory 22.

In the case where the number of consecutive authentication failures exceeds the threshold number of times, that is, in the case where a notification that the value AC-1 exceeds the value LC is sent from the counter managing unit 51, the controller 53 locks the USB memory 1 to disable the USB memory 1 or controls the flash memory I/F 39 to delete the data stored in the flash memory 22.

Processes performed by the USB memory 1 with the foregoing structure will now be described.

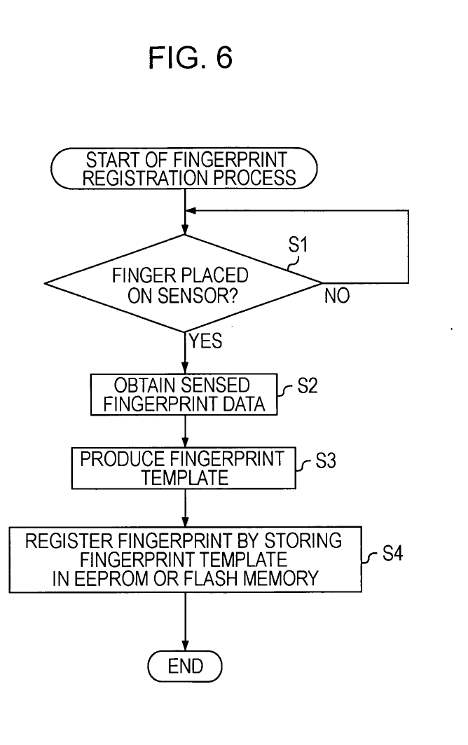

With reference to the flowchart shown in FIG. 6, a fingerprint registration process performed by the USB memory 1 will be described.

This process starts in the case where a user enters an instruction to register the user's fingerprint by, for example, operating the host PC 2 connected to the USB memory 1. At the time the user gives such an instruction, the host PC 2 sends a command for starting fingerprint registration to the USB memory 1.

In step S1, the fingerprint matching engine 37 determines whether a finger has been placed on the fingerprint sensor 11. The fingerprint matching engine 37 is on standby until it is determined that a finger has been placed on the fingerprint sensor 11.

In the case where it is determined in step S1 that a finger has been placed on the fingerprint sensor 11, in step S2, the fingerprint matching engine 37 obtains an RF signal supplied from the fingerprint sensor 11 as sensed fingerprint data.

In step S3, the fingerprint matching engine 37 produces data indicating a feature of the fingerprint sensed by the fingerprint sensor 11 as a fingerprint template. The fingerprint template produced by the fingerprint matching engine 37 is output to the cryptographic engine 34 via the bus 40.

In step S4, the cryptographic engine 34 encrypts the fingerprint template using the encryption key stored in the EEPROM 35 and outputs the encrypted fingerprint template to the flash memory I/F 39, and the flash memory I/F 39 stores the encrypted fingerprint template in the area A₁ of the flash memory 22 (FIG. 3). Alternatively, after the fingerprint template has been encrypted using the encryption key, the encrypted fingerprint template may be stored in the EEPROM 35, instead of in the flash memory 22.

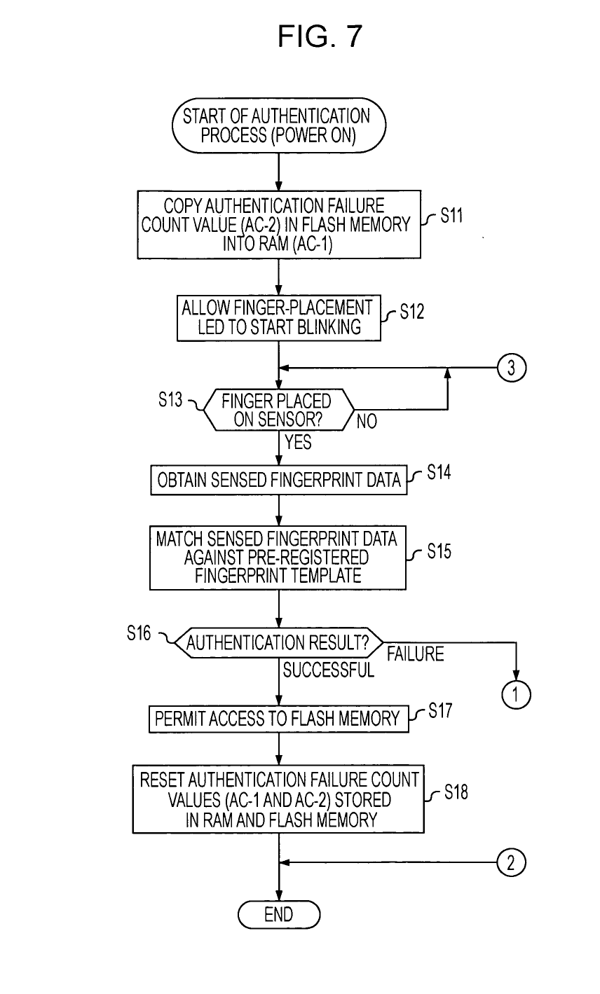

With reference to the flowcharts shown in FIGS. 7 and 8, a user authentication process performed by the USB memory 1 will now be described.

This process starts in the case where the user plugs the USB memory 1 into the USB terminal of the host PC 2. When the user plugs the USB memory 1 into the USB terminal of the host PC 2, power is supplied from the host PC 2 to the USB memory 1, and the USB memory 1 enters a power-on state.

In step S11, the counter managing unit 51 reads the value AC-2 stored in the flash memory 22 and copies the value AC-2 as the value AC-1 into the RAM 36A. In this case, the value AC-1 and the value AC-2 indicate the same number of times.

In step S12, the LED controller 32 allows the finger-placement LED 12 to start blinking, thereby prompting the user to enter an instruction to start the user authentication process.

In step S13, the fingerprint matching engine 37 determines whether a finger has been placed on the fingerprint sensor 11. The fingerprint matching engine 37 is on standby until it is determined that a finger has been placed on the fingerprint sensor 11.

In the case where it is determined in step S13 that a finger has been placed on the fingerprint sensor 11, in step S14, the fingerprint matching engine 37 obtains sensed fingerprint data on the basis of an RF signal supplied from the fingerprint sensor 11.

In step S15, the fingerprint matching engine 37 uses a fingerprint indicated by the sensed fingerprint data as a target for fingerprint matching and matches a feature extracted from the target fingerprint against a feature represented by a fingerprint template that has been decrypted using the encryption key stored in the EEPROM 35 and supplied from the cryptographic engine 34.

In step S16, the fingerprint matching engine 37 determines whether the authentication was successful. The result of determining whether the authentication was successful is sent from the fingerprint matching engine 37 to the counter managing unit 51 and the controller 53.

In the case where it is determined in step S16 that the authentication was successful, in step S17, the controller 53 permits the host PC 2 to access the flash memory 22 and controls writing of data supplied from the host PC 2 and reading of data specified by the host PC 2.

In step S18, the counter managing unit 51 resets the value AC-1 stored in the RAM 36A and the value AC-2 stored in the flash memory 22, and the process ends.

In contrast, if the feature extracted from the target fingerprint did not match the feature represented by the fingerprint template and it is determined in step S16 that the authentication failed, in step S19, the counter managing unit 51 increments the value AC-1 stored in the RAM 36A by one, thereby increasing the number of consecutive authentication failures indicated by the value AC-1.

In step S20, the counter managing unit 51 compares the value LC stored in the flash memory 22 with the value AC-1 stored in the RAM 36A and determines whether the value AC-1 exceeds the value LC.

If it is determined in step S20 that the value AC-1 exceeds the value LC, in step S21, the counter managing unit 51 sends a notification that the value AC-1 exceeds the value LC to the controller 53, and the controller 53 locks the USB memory 1 or delete the data stored in the flash memory 22. Thereafter, the process ends.

In contrast, if it is determined in step S20 that the value AC-1 does not exceed the value LC, in step S22, the counter managing unit 51 determines whether the value AC-2 stored in the flash memory 22 is zero.

If it is determined in step S22 that the value AC-2 is zero, in step S23, the counter managing unit 51 allows the random-number generator 52 to generate a random number and computes a value RC that is less than or equal to the value LC on the basis of the random number generated by the random-number generator 52. For example, a decimal numeral having a predetermined number of digits is represented as a hexadecimal numeral, and the last one digit of the hexadecimal numeral serves as the value RC. Therefore, the value RC is a random number.

For example, since the authentication was successful the last time the USB memory 1 was plugged into the host PC 2, the value indicating zero is stored as the value AC-2 in the flash memory 22. If the immediately preceding detected authentication failure was the first time, the value AC-2 is determined as zero, and the value RC is computed on the basis of the random number.

Even if the immediately preceding detected authentication failure was not the first time, a determination is performed using the value RC computed on the basis of the random number, and, if the value AC-1 stored in the RAM 36A has not been copied as the value AC-2 into the flash memory 22 yet, it is determined that the value AC-2 is zero, and the value RC is computed on the basis of the random number.

In step S24, the counter managing unit 51 determines whether the value RC is less than or equal to the value AC-1 stored in the RAM 36A.

If the value RC is less than or equal to the value AC-1 and it is determined in step S24 that the value RC is less than or equal to the value AC-1, in step S25, the counter managing unit 51 enters a number-of-consecutive-authentication-failure count-up mode and copies the value AC-1 stored in the RAM 36A as the value AC-2 into the flash memory 22. In the number-of-consecutive-authentication-failure count-up mode, the value AC-2 stored in the flash memory 22 is updated every time the authentication fails.

Accordingly, even in the case where the USB memory 1 is removed from the host PC 2 and the value AC-1 stored in the RAM 36A, which is a volatile memory, is reset, the value indicating that the number of consecutive authentication failures is at least one time is retained in the flash memory 22. Thereafter, the flow returns to step S13, and the process from step S13 onward is repeated.

If the value RC is greater than the value AC-1 and it is determined in step S24 that the value RC is greater than the value AC-1, step S25 is skipped, and the process from step S13 onward is repeated. In this case, the value AC-1 stored in the RAM 36A is not copied as the value AC-2 into the flash memory 22.

In contrast, if it is determined in step S22 that the value AC-2 stored in the flash memory 22 is not zero, that is, if the authentication has already failed and the value AC-2 indicating that the number of consecutive authentication failures is at least one time is stored in the flash memory 22 by coping the value AC-1, the counter managing unit 51 skips steps S23 and S24 and, in step S25, copies the current value AC-1 stored in the RAM 36A as the value AC-2 into the flash memory 22, thereby updating the value AC-2. Thereafter, the flow returns to step S13, and the process from step S13 onward is repeated.

As has been described above, at the time the value AC-1 exceeds the value LC indicating the threshold number of times, the USB memory 1 is locked or the data stored in the flash memory 22 is deleted, thereby preventing data leakage in a more reliable manner.

In the case where the value AC-2 stored in the flash memory 22 is zero, even if the authentication fails, the value AC-1 stored in the RAM 36A as the value indicating the latest number of consecutive authentication failures is not readily copied to the flash memory 22. Instead, the value AC-1 is copied from the RAM 36A to the flash memory 22 only when the value RC is less than or equal to the value AC-1. Accordingly, the number of erase-writes of the flash memory 22 is prevented from increasing rapidly, and the life of the flash memory 22 can be extended.

Since the time to copy the value AC-1 in the case where the value AC-2 stored in the flash memory 22 is zero is determined on the basis of the value RC computed on the basis of the random number, the time to copy the value AC-1 will not be known to a person using the USB memory 1. As a result, unauthorized acts can be avoided.

For example, in the case where the value AC-1 stored in the RAM 36A is copied to the flash memory 22 every time the value AC-1 increases by five, that is, every five consecutive authentication failures, such as five times, ten times, fifteen times, etc., and the number of consecutive authentication failures at that time is retained in the flash memory 22, if a person using the USB memory 1 knows that the value AC-1 is copied to the flash memory 22 every five consecutive authentication failures, the user can remove the USB memory 1 from the host PC 2 every four consecutive authentication failures, thereby resetting the value AC-1 and preventing the correct number of consecutive authentication failures from being retained in the flash memory 22. However, since the time to copy the value AC-1 is determined at random, such unauthorized acts are avoided.

Specific examples of updating the authentication failure count values stored in the RAM 36A and the flash memory 22 using the process shown in FIGS. 7 and 8 will now be described.

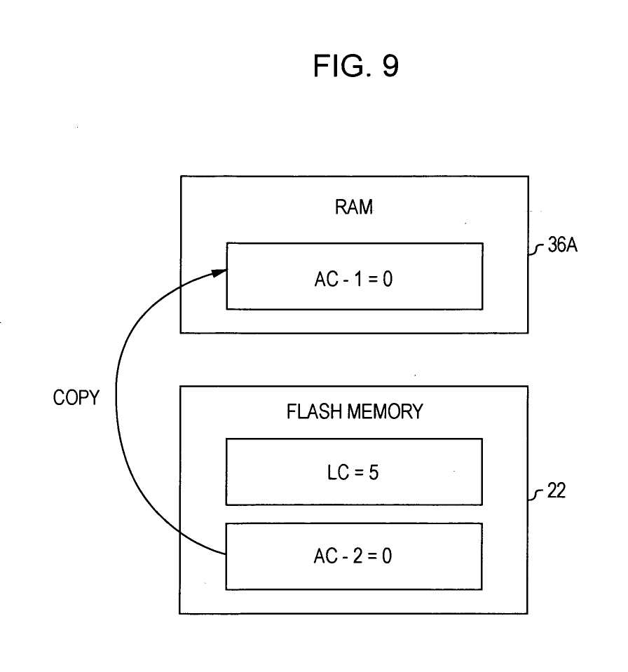

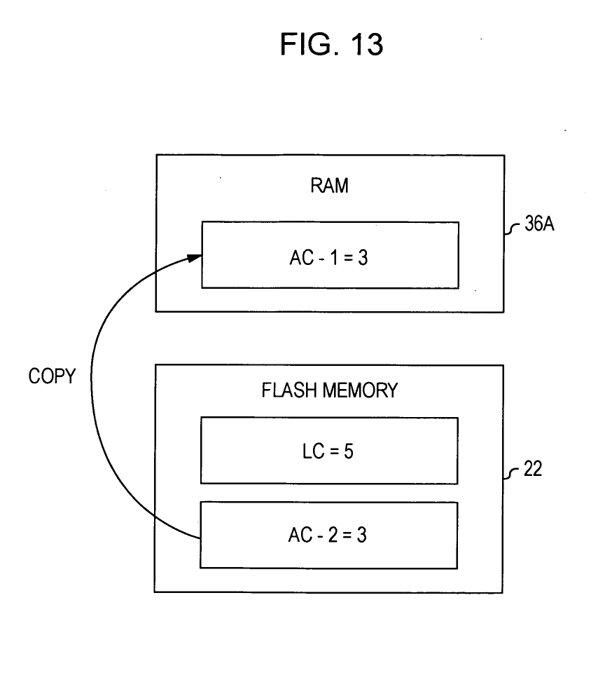

Since the user has made the setting allowing up to five consecutive failures, the case in which “5” is stored as the value LC in the flash memory 22 will be described. FIGS. 9 to 12 illustrate a first example, and FIGS. 13 to 15 illustrate a second example.

FIG. 9 illustrates an example where the USB memory 1 in which “0” is stored as the value AC-2 in the flash memory 22 since the authentication performed the last time the USB memory 1 was plugged into the host PC 2 was successful is plugged into the host PC 2.

In the case where the USB memory 1 in which “0” is stored as the value AC-2 is plugged into the host PC 2 and the power of the USB memory 1 is turned on, as shown in FIG. 9, the value AC-2 is copied and “0” is stored as the value AC-1 in the RAM 36A (step S11 of FIG. 7).

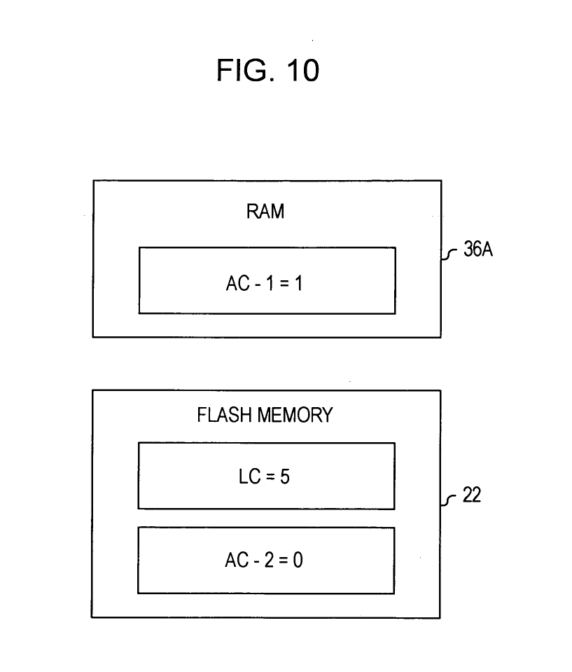

If authentication performed in the state shown in FIG. 9 in which “0” is stored as the value AC-1 failed, as shown in FIG. 10, the value AC-1 stored in the RAM 36A is incremented by one, and “1” is stored as the value AC-1 (step S19 of FIG. 8). Since the value AC-1 does not exceed the value LC, the USB memory 1 will not be locked.

For example, in the case where the value RC which is computed on the basis of a random number and which is less than or equal to the value LC is any one of “2”, “3”, “4”, and “5”, the value RC is determined not to be less than or equal to the value AC-1 (step S24 of FIG. 8), and hence the value AC-1 is not copied to the flash memory 22. Instead, as shown in FIG. 10, the value AC-2 remains as “0”.

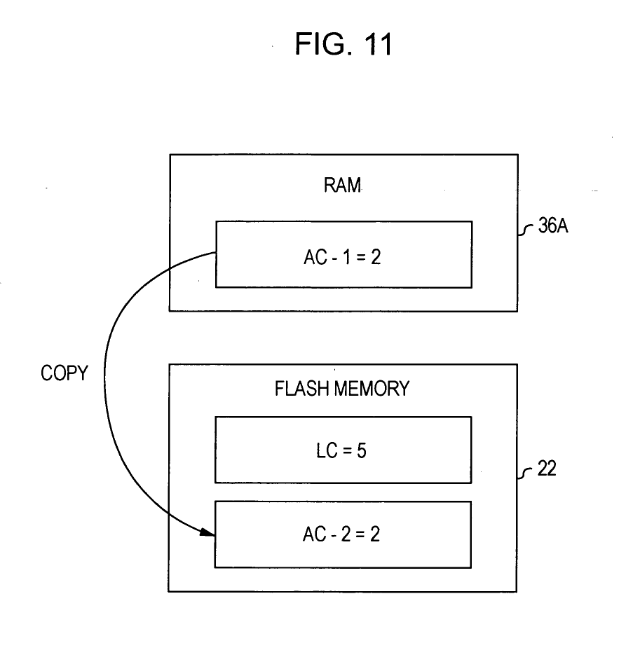

If the next authentication attempt performed in the state shown in FIG. 10 in which “1” is stored as the value AC-1 failed, as shown in FIG. 11, the value AC-1 stored in the RAM 36A is incremented by one, and “2” is stored as the value AC-1 (step S19 of FIG. 8). Since the value AC-1 does not exceed the value LC, the USB memory 1 will not be locked.

For example, in the case where the value RC which is computed on the basis of a random number and which is less than or equal to the value LC is any one of “1” and “2”, the value RC is determined to be less than or equal to the value AC-1 (step S24 of FIG. 8), and hence the mode is changed to the number-of-consecutive-authentication-failure count-up mode. As shown in FIG. 11, the value AC-1 is copied as the value AC-2 into the flash memory 22, and the value AC-2 is set to “2”. Accordingly, the number of consecutive authentication failures remains as two times in the flash memory 22 even if the USB memory 1 is removed from the host PC 2 in this state.

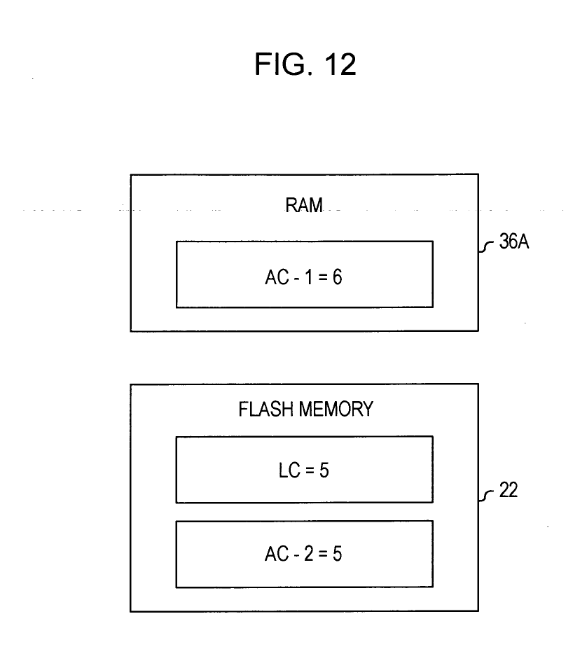

When repeated authentication attempts have failed and the value AC-1 stored in the RAM 36A has been incremented one-by-one, and, as a result, as shown in FIG. 12, if “6” is stored as the value AC-1, it is determined that the value AC-1 exceeds the value LC (step S20 of FIG. 8). Thus, the USB memory 1 is locked, or the data stored in the flash memory 22 is deleted (step S21 of FIG. 8). The locked USB memory 1 may be unlocked by performing initialization, such as by pressing a dedicated button.

In the number-of-consecutive-authentication-failure count-up mode, the value AC-2 stored in the flash memory 22 is also updated every time the authentication fails. In FIG. 12, the value AC-2 is set to “5”.

FIG. 13 illustrates an example where the USB memory 1 in which “3” is stored as the value AC-2 in the flash memory 22 since three consecutive authentication attempts performed the last time the USB memory 1 was plugged into the host PC 2 were unsuccessful is plugged into the host PC 2.

In the case where the USB memory 1 in which “3” is stored as the value AC-2 is plugged into the host PC 2 and the power of the USB memory 1 is turned on, as shown in FIG. 13, the value AC-2 is copied and “3” is stored as the value AC-1 in the RAM 36A (step S11 of FIG. 7).

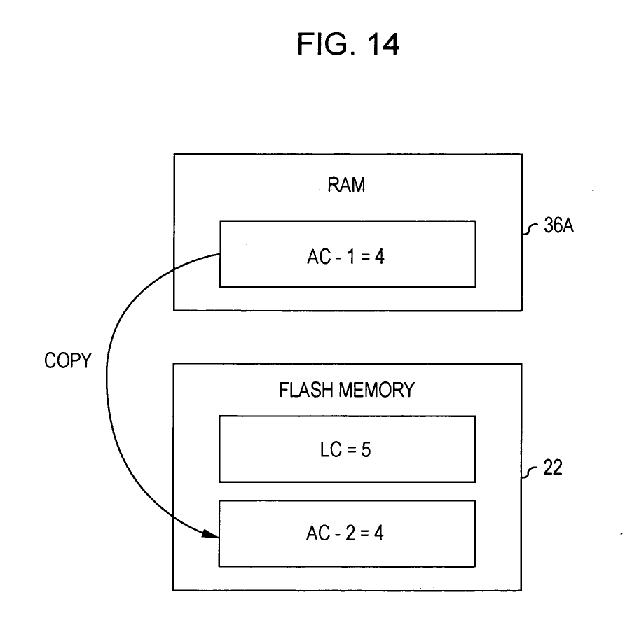

If authentication performed in the state shown in FIG. 13 in which “3” is stored as the value AC-1 failed, the number of consecutive authentication failures becomes four times. As shown in FIG. 14, the value AC-1 stored in the RAM 36A is incremented by one, and “4” is stored as the value AC-1 (step S19 of FIG. 8). Since the value AC-1 does not exceed the value LC, the USB memory 1 will not be locked.

For example, in the case where the value RC which is computed on the basis of a random number and which is less than or equal to the value LC is any one of “1”, “2”, “3”, and “4”, the value RC is determined to be less than or equal to the value AC-1 (step S24 of FIG. 8), and the mode is changed to the number-of-consecutive-authentication-failure count-up mode. As shown in FIG. 14, the value AC-1 is copied as the value AC-2 into the flash memory 22, and the value AC-2 is set to “4”. Accordingly, the number of consecutive authentication failures remains as four times in the flash memory 22 even if the USB memory 1 is removed from the host PC 2 in this state.

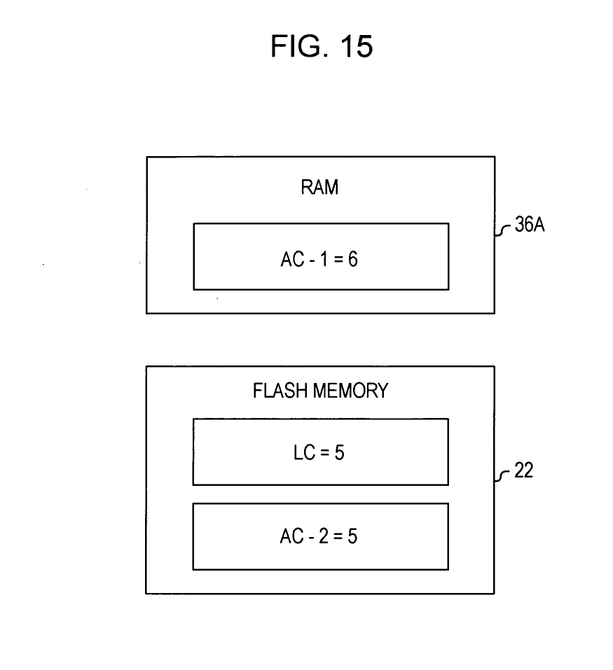

When repeated authentication attempts have failed and the value AC-1 stored in the RAM 36A has been incremented one-by-one, and, as a result, as shown in FIG. 15, if “6” is stored as the value AC-1, it is determined that the value AC-1 exceeds the value LC (step S20 of FIG. 8). The USB memory 1 is locked, or the data stored in the flash memory 22 is deleted (step S21 of FIG. 8).

By managing the count values in the foregoing manner, unauthorized acts are prevented, and the life of the flash memory 22 can be extended.

In the foregoing description, it is assumed that user authentication is performed using a fingerprint sensed by the fingerprint sensor 11. However, user authentication is not necessarily performed using a fingerprint. Other biometric authentication may be performed as long as user authentication can be performed in the USB memory 1. For example, user authentication may be performed using an iris or a palmprint.

In the case where the USB memory 1 has a touch panel, user authentication may be performed on the basis of a password entered by touching the surface of the touch panel with a finger.

The series of processes described above can be performed using hardware or software. If software is employed to perform this series of processes, a program constituting the software is installed from a program recording medium onto a computer included in dedicated hardware or, for example, an apparatus capable of performing various functions using various programs installed thereon.

The program executed by the apparatus may be recorded on a packed medium including a magnetic disk (including a flexible disk), an optical disk (including a compact disc-read only memory (CD-ROM) and a digital versatile disc (DVD)), a magneto-optical disk, or a semiconductor memory and provided to the apparatus, or may be provided via a wired or wireless transmission medium, such as a local area network (LAN), the Internet, or digital satellite broadcasting.

The program executed by the apparatus may be a program allowing a series of steps to be performed sequentially in the order described in the flowcharts, as well as a series of steps performed in parallel or at a necessary time such as when a series of steps is called.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device including a non-volatile memory and connectable to an information processing apparatus, comprising:
sensing means for sensing biometric information;
authentication means for performing user authentication on the basis of the biometric information sensed by the sensing means;
management means for managing a number of authentication failures, the number of authentication failures being the number of times the authentication performed by the authentication means has failed; and
control means for disabling the electronic device or deleting data stored in the non-volatile memory in a case where the number of authentication failures exceeds a preset threshold number of times.

2. The electronic device according to claim 1, further comprising a volatile memory,
wherein the management means manages the number of authentication failures by updating a first count value indicating the number of authentication failures as a first number of times, the first count value being stored in the volatile memory, and
wherein the control means disables the electronic device or deletes the data stored in the non-volatile memory in a case where the first number of times exceeds the threshold number of times.

3. The electronic device according to claim 2, wherein the management means stores a second count value indicating a second number of times in the non-volatile memory at a predetermined time, the second number of times being the same number of times as the first number of times.

4. The electronic device according to claim 3, wherein, in a case where at least partial operation of the electronic device is performed using power supplied from the information processing apparatus connected to the electronic device, the management means stores in the volatile memory the first count value indicating the first number of times, the first number of times being the same number of times as the second number of times, when the electronic device is connected to the information processing apparatus and power is supplied from the information processing apparatus to the electronic device.

5. The electronic device according to claim 3, further comprising computing means for randomly computing a value indicating a number of times less than or equal to the threshold number of times,
wherein the management means stores in the non-volatile memory the second count value indicating the second number of times, the second number of times being the same number of times as the first number of times, at a time when the number of times indicated by the value computed by the computing means is less than or equal to the first number of times.

6. The electronic device according to claim 3, wherein the management means resets the first count value and the second count value in a case where the authentication performed by the authentication means is successful.

7. The electronic device according to claim 1, wherein the management means manages a value indicating the threshold number of times by storing the value indicating the threshold number of times in the non-volatile memory.

8. An information processing method for an electronic device including a non-volatile memory and connectable to an information processing apparatus, comprising the steps of:
sensing biometric information;
performing user authentication on the basis of the sensed biometric information;
managing the number of times the authentication has failed; and
disabling the electronic device or deleting data stored in the non-volatile memory in a case where the managed number of times exceeds a preset threshold number of times.

9. An electronic device including a non-volatile memory and connectable to an information processing apparatus, comprising:
a sensor configured to sense biometric information;
an authentication unit configured to perform user authentication on the basis of the biometric information sensed by the sensor;
a management unit configured to manage a number of authentication failures, the number of authentication failures being the number of times the authentication performed by the authentication unit has failed; and
a controller configured to disable the electronic device or delete data stored in the non-volatile memory in a case where the number of authentication failures exceeds a preset threshold number of times.
